(19) United States
(12) Patent Application Publication
(10) Pub. No.: US 2024/0249867 A1
(43) Pub. Date: Jul. 25, 2024

(54) SYMMETRICAL INDUCTIVE POSITION SENSOR

(71) Applicant: VITESCO TECHNOLOGIES GMBH, Regensburg (DE)

(72) Inventor: Alain FONTANET, Toulouse (FR)

(21) Appl. No.: 18/562,647

(22) PCT Filed: May 11, 2022
(86) PCT No.: PCT/EP2022/062732

§ 371 Date: Nov. 20, 2023

(30) Foreign Application Priority Data
May 25, 2021 (FR) FR2105385

(51) Int. Cl. H01F 27/00; G01B 7/00; G01D 5/20; H01F 27/28

(52) U.S. Cl. CPC H01F 27/006; G01B 7/003; G01D 5/2053; H01F 27/2804; H01F 2027/2809

(57) ABSTRACT

An inductive position sensor includes, on the one hand, a primary coil and, on the other hand, at least one secondary coil that includes at least two secondary windings each consisting of a plurality of turns formed on two layers of a printed circuit board. Each of the turns has a first generally concave portion placed on one layer of the printed circuit board and a second generally concave portion placed on another layer of the printed circuit board. Among the first portions and second portions of the turns of the two secondary windings, at least some of these first and second portions are arranged in mirror symmetry on either side of a transverse separation plane, this transverse separation plane being located between the two secondary windings and being orthogonal to the longitudinal direction.

### TECHNICAL FIELD

The present invention relates to an inductive position sensor.

This type of sensor has the advantage of making it possible to determine the position of a mechanical part, or of any other element, without requiring contact with the part the position of which it is desired to ascertain. This advantage means that such sensors have very many applications in all types of industries. Such sensors are also used in mass-market applications such as, for example, the automotive field, in which the present invention was made. However, the present invention may be employed in other fields.

The operating principle of an inductive sensor is based on the variation in coupling between a primary winding and secondary windings of a transformer operating at high frequency and without the use of a magnetic circuit. The coupling between these windings varies as a function of the position of a moving (electrically) conductive part, generally called the “target”. Specifically, currents induced in the target modify the currents induced in the secondary windings. By adjusting the configuration of the windings and knowing the current injected into the primary winding, measurement of the voltage induced in the secondary windings allows the position of the target to be determined.

### PRIOR ART

To incorporate such an inductive sensor into a device, in particular an electronic device, it is known practice to produce the transformer mentioned above on a printed circuit board. The primary winding and the secondary windings then consist of tracks drawn on the printed circuit board. The primary winding is then for example supplied with power by an external source and the secondary windings are the site of voltages induced by the magnetic field created by a current flowing through the primary winding. The target, which is a conductive part, a metal part for example, may have a simple shape. It may for example be a part cut from a metal sheet. To produce a linear sensor, the cut-out used to produce the target is for example rectangular, whereas, to produce a rotary sensor, this cut-out will for example take the form of an angular sector of radius and angle tailored to the motion of the part.

Generally, two sets of secondary windings are drawn so as to produce, over one complete movement of the sensor, sine and cosine functions of the position of the target. Such functions (cos and sin) are well known and may easily be processed by an electronic system. By determining the ratio of the sine to the cosine and then applying an arctangent function, an image of the position of the target is obtained. The argument of the sine and cosine functions is a linear (or affine) function of the position of the target, the movement of which then represents a greater or lesser portion of the spatial period of these trigonometric functions.

To obtain induced currents that can be measured reliably, it is preferable to have either a high number of turns or turns of large size. The second option is incompatible with production of a compact sensor. Thus, it is generally chosen to employ a high number of turns.

In order to limit the space occupied on the printed circuit board, it has been proposed, in particular in document FR3002034, to produce turns used to form the secondary windings on two distinct layers of the printed circuit board. To do this, vias passing through the printed circuit board are provided in order to allow the turns thus produced to be connected. Such a turn has successive first and second sectors in a longitudinal direction of the turn. The arrangement of turns of the secondary windings of such an inductive position sensor is easy to produce and limits, for a given number of turns, the number of vias to be produced in the corresponding printed circuit board, and the turns may be arranged in a compact manner in order to limit the bulk of the sensor.

### SUMMARY OF THE INVENTION

The aim of the invention is to improve the inductive position sensors of the prior art, in particular as regards their linearity and their accuracy.

To this end, the invention targets an inductive position sensor comprising, on the one hand, a primary coil and, on the other hand, at least one secondary coil that comprises at least two secondary windings each consisting of a plurality of turns formed on at least two layers of a printed circuit board, each of these two secondary windings being arranged as follows:
the secondary winding comprises turns each having substantially the same shape;
said turns are aligned in a longitudinal direction with each time an offset in the longitudinal direction;
each of said turns has a first generally concave portion placed on one layer of the printed circuit board and a second generally concave portion placed on another layer of the printed circuit board;
the first portion of a turn is connected to the second portion of the same turn by a first via passing through the printed circuit board;
the first portion of a turn is connected to the second portion of a neighboring turn by a second via passing through the printed circuit board;
the first portion of a turn has a first edge extending from the first via, a second edge extending from the second via and a bottom connecting the first and second edges;
the first edge and the second edge converge with distance from the corresponding first and second vias;
an offset in the longitudinal direction between two neighboring turns is less than a distance separating the bottom of a first portion of a turn and an axis passing through the corresponding first and second vias.

In addition, among the first portions and second portions of the turns of the two secondary windings, at least some of these first and second portions are arranged in mirror symmetry on either side of a transverse separation plane, this transverse separation plane being located between the two secondary windings and being orthogonal to the longitudinal direction.

Mirror symmetry designates, as known, planar symmetry relative to a plane of symmetry, here said transverse separation plane.

It will be noted that the mirror symmetry according to the invention relates to the secondary windings in question in the three dimensions of space, and not to a simple orthogonal projection of said secondary windings.

The expression “comprising two secondary windings” is here to be interpreted to mean “comprising at least two secondary windings”.

Such an inductive position sensor benefits from an improvement in its accuracy and its linearity.

The measurements of voltage across the terminals of the secondary coils of such a sensor produce sinusoidal signals the symmetry of the negative and positive amplitudes of which is improved. In addition, the positions of the target that theoretically should correspond to a zero voltage across the terminals of a secondary coil, actually correspond, by virtue of this symmetrical arrangement, to a value close to zero. Adjustment of the electronics of the sensor is facilitated as regards compensation for the residual offset of the signals, this offset being decreased at its source. Decreasing this residual offset of the signals makes it possible to easily adjust the electronics of the sensor and therefore the electric machine with which the sensor is associated, without increasing bulk and while keeping the usual shape of this type of sensor.

The inductive position sensor according to the invention is particularly suitable for measuring the angular position of a rotor of a rotary machine.

The invention is particularly suitable for electrification of vehicles, whether that be in vehicles with electric propulsion or in the increasing number of functions performed by electric motors within ICE powertrains. These electric motors are generally permanent-magnet synchronous motors the efficiency of which is high but which require to be driven precise knowledge of the angular position of the rotor. The sensor according to the invention is insensitive to the magnetic field of the permanent magnets (in the case where the power supply of the primary is high-frequency) while providing linear and more accurate position data.

The inductive position sensor according to the invention is also particularly suitable for measuring the angular position of a rotor based solely on an angular sector interacting with multiple targets joined to the rotor, thus promoting the compactness of the inductive position sensor.

### Advantageously:

the second portion of a turn is connected to the first portion of the same turn by said first via passing through the printed circuit board;
the second portion of a turn is connected to the first portion of a neighboring turn by a third via passing through the printed circuit board; and
the second portion of a turn has a first edge extending from the first via, a second edge extending from the third via and a bottom connecting the first and second edges.

The inductive position sensor may comprise the following additional features, alone or in combination:
the sensor comprises a first secondary coil comprising a first secondary winding and a second secondary winding that are electrically connected at a first transverse separation plane, the first portions of the turns of each of said first secondary winding and second secondary winding extending symmetrically on either side of the first transverse separation plane, on a first layer of the printed circuit board;
the second portions of the turns of each of said first secondary winding and second secondary winding extend symmetrically on either side of the first transverse separation plane, on a second layer of the printed circuit board;
the sensor comprises a second secondary coil comprising a third secondary winding and a fourth secondary winding that are electrically connected at a second transverse separation plane, the first portions of the turns of each of said third secondary winding and fourth secondary winding extending symmetrically on either side of the second transverse separation plane, on a third layer of the printed circuit board;
the second secondary coil in addition comprises a fifth secondary winding electrically connected to the fourth secondary winding at a third transverse separation plane, the second portions of the turns of each of said fourth secondary winding and fifth secondary winding extending symmetrically on either side of the third transverse separation plane, on a fourth printed-circuit-board layer;
the first secondary coil and the second secondary coil are interleaved so that the plane corresponding to the magnetic medium of the first secondary coil coincides with the plane corresponding to the magnetic medium of the second secondary coil;
the plane corresponding to the magnetic medium of the first secondary coil and the plane corresponding to the magnetic medium of the second secondary coil coincide with the median plane of the printed circuit board;
the secondary windings are placed so that the electromotive forces induced in the turns of one of the secondary windings oppose the electromotive forces induced in the turns of the other secondary winding.

### PRESENTATION OF THE FIGURES

FIG. 1 shows in perspective an inductive position sensor according to the invention;

FIG. 2 shows the sensor according to the invention, seen from the front;

FIG. 3 shows the first secondary coil of the sensor according to the invention;

FIG. 4 shows the second secondary coil of the sensor according to the invention;

FIG. 5 shows the first secondary coil of the sensor according to the invention, seen in perspective;

FIG. 6 shows the second secondary coil of the sensor according to the invention, seen in perspective.

### DETAILED DESCRIPTION

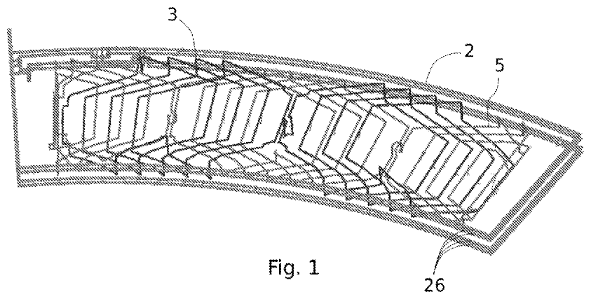

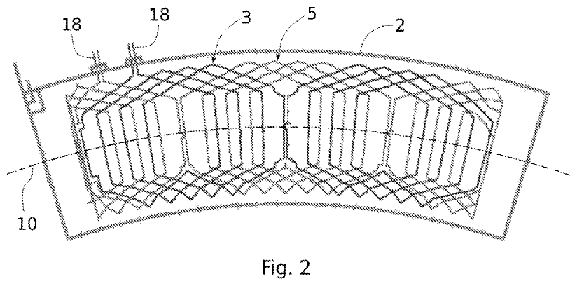

FIGS. 1 and 2 show an inductive position sensor according to the invention, in perspective and from the front, respectively. This sensor has a circularly arcuate general shape and is, in this example, configured to measure the angular position of the rotor of an electric motor, on which a target (not shown) is mounted. The target is preferably an aluminum part. Preferably, the rotor comprises as many targets as the motor comprises pairs of poles, and the dimensions of the inductive position sensor are configured so that the covered angular sector makes it possible for the sensor to always face at least one target.

This inductive position sensor here comprises a primary coil 2 and two secondary coils 3, 5, each formed by a plurality of windings. These windings are formed by conductive tracks etched on a printed circuit board and are described in detail below.

The inductive position sensor is akin to a transformer with a primary transmit coil and secondary receive coils, and its operating principles are known in the prior art.

The primary coil 2 comprises turns 26 that are also formed on a plurality of layers of the printed circuit board, so as to encircle the turns of the secondary coils 3, 5.

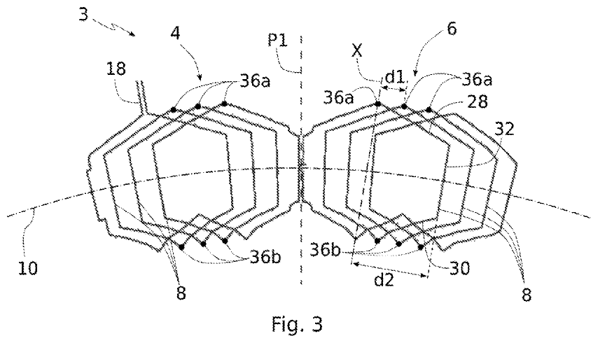

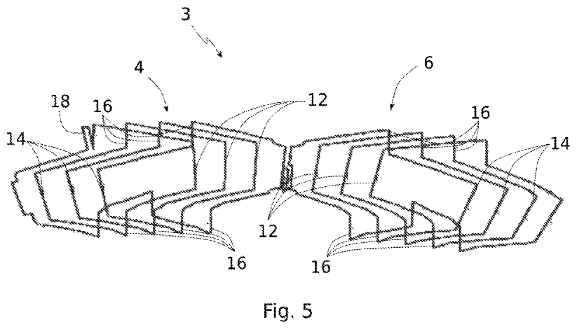

FIG. 3 shows a top view of the first secondary coil 3 which comprises, in this example, a first secondary winding 4 and a second secondary winding 6. The secondary coil 3 is also shown in perspective in FIG. 5. Each of these two windings has turns 8. It will be noted that, for each of these windings, the turns 8 are all substantially similar but each time offset relative to each other in a longitudinal direction 10. In this example of application, the longitudinal direction 10 is an arc of a circle. As a variant, in the case of a linear position sensor for example, the longitudinal direction 10 is rectilinear.

In one preferred embodiment, the longitudinal offset between two neighboring turns is the same each time. Furthermore, again preferably, the second secondary winding 6 is similar to the first secondary winding 4. The number of turns of the two windings 4, 6 is the same and the area of the turns is also the same.

The first secondary winding 4 and the second secondary winding 6 are electrically connected at a first transverse separation plane P1 in such a way that, for a given variable magnetic flux, the electromotive forces induced in the first secondary winding 4 oppose the electromotive forces induced in the second secondary winding 6.

The first transverse separation plane P1 is located between the two windings 4, 6 and is orthogonal to the longitudinal direction 10. In the present example where the longitudinal direction 10 is an arc of a circle, the transverse separation plane is therefore orthogonal to a tangent to the curve defined by the longitudinal direction 10.

Within the same winding, it will be noted that the electromotive forces induced by a variable magnetic flux in each of the turns 8 add up. This first secondary coil 3 comprises two connection tracks 18 allowing its secondary windings 4, 6 to be connected to an apparatus for measuring the voltage prevailing across the terminals thereof.

Each of these secondary windings 4, 6 comprises turns 8 that are offset longitudinally (along the same longitudinal axis 10), each comprising a concave upper first portion 12, a lower second portion 14 of opposite concavity, and linking sections 16 between the upper portion 12 and the lower portion 14. Connection tracks 18 moreover allow the coil 3 to be connected to the measuring circuit.

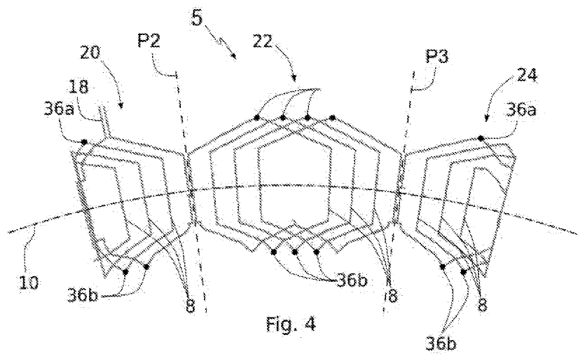

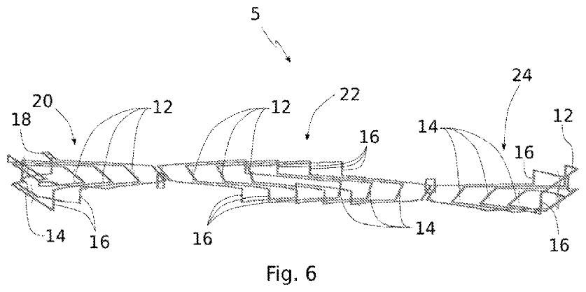

The assembly formed by the first secondary winding 4 and by the second secondary winding 6 for example allows a sine function to be produced when a conductive target moves in proximity to these windings. To produce a cosine function during movement of the target, it is known to use a second secondary coil 5 nested in the first secondary coil 3. The second secondary coil 5 is illustrated by itself from the front in FIG. 4 and in perspective in FIG. 6.

In this example, the second secondary coil 5 comprises three windings; a third secondary winding 20, a fourth secondary winding 22 and a fifth secondary winding 24.

As a variant, it is also possible to produce the sine function by means of a second secondary coil 5 that is identical to the first secondary coil 3 but that is offset linearly with respect to the first secondary coil 3, in the longitudinal direction 10, by a distance corresponding to an offset of 90° (i.e. identical to the offset of the curves representative of the mathematical functions COS and SIN). Producing the sine function and the cosine function with two identical coils takes up more space on the printed circuit board but simplifies the sensor.

In the present example of a second secondary coil comprising three windings, each of these secondary windings 20, 22, 24 (illustrated in FIG. 4) is produced in the same way as the first secondary winding 4 and the second secondary winding 6. Each of these windings 20, 22, 24 comprises turns 8 that are offset longitudinally (along the same longitudinal axis 10), each comprising a concave upper first portion 12, a lower second portion 14 of opposite concavity, and linking sections 16 between the upper portion 12 and the lower portion 14. In addition, connection tracks 18 are also found in the assembly formed by the third secondary winding 20, the fourth secondary winding 22 and the fifth secondary winding 24.

The third secondary winding 20 and the fourth secondary winding 22 are connected to each other at a second transverse separation plane P2 in such a way that, for a given variable magnetic flux, the electromotive forces induced in the third secondary winding 20 oppose the electromotive forces induced in the fourth secondary winding 22. In addition, the fourth secondary winding 22 and the fifth secondary winding 24 are connected to each other at a third transverse separation plane P3 in such a way that, for a given variable magnetic flux, the electromotive forces induced in the fourth secondary winding 22 oppose the electromotive forces induced in the fifth secondary winding 24. Within the same winding, it will be noted that the electromotive forces induced by a variable magnetic flux in each of the turns 8 add up.

As for the first transverse separation plane P1, the second transverse separation plane P2 and the third transverse separation plane P3 are orthogonal to the longitudinal direction 10 and are each placed between two windings.

FIGS. 1 and 2 illustrate the interleaving of these two secondary coils 3, 5. The interleaving is achieved by making the longitudinal axes 10 of the coils 3, 5 coincide. In one preferred embodiment (not shown), it is chosen to create redundancy in order to be able to carry out two position measurements and thus to be able to identify potential failure of the position sensor. Redundant secondary windings are then provided.

The secondary windings, just like the primary coil 2, are produced on the same printed circuit board in such a way that the secondary windings are centered inside the primary winding 2. The latter has turns 26 placed in such a way that the longitudinal axis 10 is also the longitudinal axis for the primary winding 2. It is thus possible for each turn of a secondary winding to be at the same distance from the primary winding 2 as another secondary-winding turn. Each turn may thus provide the same coupling, thus facilitating adjustment of the windings with a view to ensuring the accuracy of the sensor is good.

The shape of the turns is preferably optimized so as to allow a higher number of turns to be placed in the smallest possible given area, or more exactly the smallest possible given volume. The substantially hexagonal shape of the turns allows this optimization. The hexagonal shape of the turns is not perfect since the hexagons are not truly closed because of the offset between two neighboring turns. However, each half-turn has three sides (two edges and a bottom) forming an irregular half-hexagon.

FIGS. 5 and 6 illustrate the first secondary coil 3 and the second secondary coil 5, respectively, the coils being shown in perspective so as to allow the path of the turns to be seen in light of the path of the tracks etched on the printed circuit board (the latter not having been shown).

In summary, for each secondary coil 3, 5, one or more windings deliver a positive signal, and one or more windings deliver a negative signal. Each winding is composed of a plurality of turns 8. Each turn 8 is composed of two portions, in half-turn form. Each half-turn is positioned on a layer of the printed circuit board. The two constituent half-turns of a turn are positioned on two different layers of the printed circuit board and are connected by vias.

With reference to FIG. 5, the first secondary coil 3 comprises turns 8 that each have an upper first portion 12 (forming a first half-turn) and a lower second portion 14 (forming a second half-turn), the upper first portion 12 corresponding to a track etched on one layer of a printed circuit board and the lower second portion 14 corresponding to a track etched on another layer of the same printed circuit board. Electrical continuity between said tracks forming the upper first portion 12 and the lower second portion 14 is ensured by a first via 36a (see FIG. 3) passing through the printed circuit board, within which via a section 16 ensures said electrical continuity. The same goes for the second secondary coil 5.

Electrical continuity between two neighboring turns is ensured in the following way: the first portion 12 of a turn is connected to the second portion of a neighboring turn by a second via 36b (see FIGS. 3 and 4) passing through the printed circuit board, within which via a section 16 ensures said electrical continuity. Each upper first portion 12 and each lower second portion 14 has, in the embodiment shown in the drawing, the shape of an (irregular) half-hexagon. Each upper first portion 12 and each lower second portion 14 thus has a generally concave shape, the concavity of the upper first portion 12 of a turn 8 being oriented opposite to the concavity of the lower second portion 14 of the same turn. More generally, in a secondary winding, the upper portions 12 have a concavity oriented on a first side and the lower portions 14 have a concavity oriented on the side opposite the first side. It is thus possible to have lower and/or upper portions of circularly arcuate shape, of elliptically arcuate shape, of semi-octagonal shape, etc.

The sections 16, the position of which also corresponds to that of the first and second vias 36a, 36b to which they are connected, are aligned on two circular arcs, both lying at equal distance on either side of the longitudinal axis 10.

Preferably, again for the sake of optimization, the half-turns are regularly distributed with a regular offset. The offset d1 (see FIG. 3) in the longitudinal direction between two adjacent turns, i.e. between two neighboring first vias 36a or two neighboring second vias 36b, is smaller than a distance d2 between the bottom 32 of a first portion 12 of a turn 8 and an axis X passing through the corresponding first and second vias 36a, 36b (see FIG. 3). This makes it possible to optimize the number of turns in a given area.

In addition, at least some of the turns of the first secondary coil 3 are arranged in mirror symmetry on either side of the first transverse separation plane P1, which is between the two windings 4 and 6. It is the turns, and in particular the upper portions 12 and lower portions 14, that are placed in mirror symmetry, and not the whole of the actual coil 3 itself.

This arrangement in mirror symmetry of the turns corresponds precisely, in this example, to the fact that:
all the turns 8 lying to the right of the separation plane P1 (in the view of FIG. 5) are arranged so that their respective upper first portion 12 faces the side of the transverse separation plane P1, and that their lower second portion 14 faces the opposite side to the transverse separation plane P1;
all the turns 8 lying to the left of the separation plane P1 (in the view of FIG. 5) are arranged so that their respective upper first portion 12 faces the side of the transverse separation plane P1, and that their lower second portion 14 faces the opposite side to the transverse separation plane P1.

In other words, the upper first portions 12 of each turn 8 are placed symmetrically on either side of the transverse separation plane P1, on the same layer of the printed circuit board. Likewise, the lower second portions 14 of each turn 8 are also placed symmetrically on either side of the transverse separation plane P1, both on the same layer of the printed circuit board, which layer is different from the previous one.

When the target to be detected straddles the transverse separation plane P1, it is therefore facing the upper first portion 12 of the two turns flanking the transverse separation plane P1. The target is therefore facing two half-turns, one of which delivers a positive signal and the other of which delivers a negative signal. The target is equidistant from these two half-turns (which are on the same layer of the printed circuit board). The coupling therefore here corresponds to a voltage value of zero (or close to zero), which is in accordance with the theoretical model of the sensor. A sensor that is more linear, more accurate, and easier to adjust is thus obtained.

Likewise, if two targets (in the case of a sensor comprising a plurality of angularly distributed targets on a rotor) are, at a given time, each facing one lateral end of the sensor, these two targets will each face half-turns corresponding to the lower second portions of the turns of each edge of the sensor. Likewise, the coupling will here also return a value of zero (or close to zero) and will be more in accordance with the theoretical model of the sensor.

With reference to FIG. 6, the second secondary coil 5 is arranged according to the same principles as the first secondary coil 3. The windings 20, 22, 24 are symmetrical pairwise with respect to the transverse separation planes P2, P3.

For the third and fourth windings 20, 22, the upper first portions 12 of the turns which are placed on either side of the second transverse separation plane P2 are arranged in mirror symmetry. In other words, the upper half-turns of the two windings 20, 22 are turned toward the side of the transverse separation plane P2.

In this example relating to the second secondary coil 5, the third winding 20 being truncated with respect to the fourth winding 22, only the upper first portions 12 of the turns are arranged in mirror symmetry.

For the fourth and fifth windings 22, 24, the lower second portions 14 of the turns which are placed on either side of the third transverse separation plane P3 are arranged in mirror symmetry. In other words, the lower half-turns of the two windings 22, 24 are turned toward the side of the transverse separation plane P3.

Likewise, as above, the fifth winding 24 being truncated with respect to the fourth winding 22, only the lower second portions 14 of the turns are arranged in mirror symmetry.

Preferably, the height of the sections 16 of the second coil 5 is smaller than the height of the sections 16 of the first coil 2, and the second coil 5 is housed, within the printed circuit board, in a median position with respect to the first coil 3. Preferably, the printed circuit board is a four-layer board and:
the upper first portions 12 and lower second portions 14 of the second secondary coil 5 are etched on the two internal layers of the board;
the upper first portions 12 and lower second portions 14 of the first secondary coil 3 are etched on the two external layers of the board.

Preferably, the plane corresponding to the magnetic medium of the first secondary coil 3 coincides with the plane corresponding to the magnetic medium of the second secondary coil 5, and corresponds to the median plane of the printed circuit board. The target thus acts on the sine signal and on the cosine signal at the same distance, this contributing to improving the linearity of the sensor.

Moreover, as a variant, the sensor may in addition incorporate the improvements described in the document FR3068464. Thus, each of the turns being divided, in one turn length, into a first sector and a second sector, which are complementary and successive:
the first sector is divided, in one turn width, into a first segment that is placed on a first layer of the printed circuit board, and a second segment that is placed on a second layer of the printed circuit board, the first and second segments of the first sector being complementary;
the second segment of the first sector is extended, in the length of the turn, by a first segment of the second sector, which segment is placed on the first layer of the printed circuit board;
the first segment of the second sector is extended, in the width of the turn, by a second segment of the second sector, which segment is placed on the second layer of the printed circuit board, the first and second segments of the second sector dividing the second sector widthwise while being complementary;
the first segment of the first sector is connected to the second segment of the second sector of a neighboring turn;
the first and second segments of the first sector, the second segment of the first sector and the first segment of the second sector, the first segment of the second sector and the second segment of the second sector as well as the second segment of the second sector of a neighboring turn and the first segment of the first sector are connected by a respective via passing through the printed circuit board.

Thus, according to this variant, each half-turn may itself be distributed over two printed-circuit-board layers. This variant does not improve linearity but decreases the sensitivity of the sensor to variation in gap value.

Other variants of the inductive position sensor may be envisioned. In particular, the number, arrangement and shape of the coils employed may be changed, provided that at least two windings of a secondary coil comprise half-turns arranged in mirror symmetry on either side of a transverse separation plane.

1. An inductive position sensor comprising, both a primary coil and at least one secondary coil that comprises at least two secondary windings each consisting of a plurality of turns formed on at least two layers of a printed circuit board, each of these at least two secondary windings being arranged as follows:
the secondary winding comprises turns each having substantially the same shape;
said turns are aligned in a longitudinal direction with each time an offset in the longitudinal direction;
each of said turns has a first generally concave portion placed on one layer of the printed circuit board and a second generally concave portion placed on another layer of the printed circuit board;
the first portion of a turn is connected to the second portion of the same turn by a first via passing through the printed circuit board;
the first portion of a turn is connected to the second portion of a neighboring turn by a second via passing through the printed circuit board;
the first portion of a turn has a first edge extending from the first via, a second edge extending from the second via and a bottom connecting the first and second edges;
the first edge and the second edge converge with distance from the corresponding first and second vias;
an offset in the longitudinal direction between two neighboring turns is less than a distance separating the bottom of a first portion of a turn and an axis passing through the corresponding first and second vias;
wherein, among the first portions and second portions of the turns of the at least two secondary windings, at least some of these first and second portions are arranged in mirror symmetry on either side of a transverse separation plane, this transverse separation plane being located between the at least two secondary windings and being orthogonal to the longitudinal direction.

2. The inductive position sensor as claimed in claim 1, further comprising a first secondary coil comprising a first secondary winding and a second secondary winding that are electrically connected at a first transverse separation plane, the first portions of the turns of each of said first secondary winding- and second secondary winding extending symmetrically on either side of the first transverse separation plane, on a first layer of the printed circuit board.

3. The inductive position sensor as claimed in claim 2, wherein the second portions of the turns of each of said first secondary winding and second secondary winding extend symmetrically on either side of the first transverse separation plane-, on a second layer of the printed circuit board.

4. The inductive position sensor as claimed in claim 2, further comprising a second secondary coil comprising a third secondary winding and a fourth secondary winding that are electrically connected at a second transverse separation plane, the first portions of the turns of each of said third secondary winding- and fourth secondary winding extending symmetrically on either side of the second transverse separation plane, on a third layer of the printed circuit board.

5. The inductive position sensor as claimed in claim 4, wherein the second secondary coil in addition comprises a fifth secondary winding electrically connected to the fourth secondary winding at a third transverse separation plane, the second portions of the turns of each of said fourth secondary winding and fifth secondary winding extending symmetrically on either side of the third transverse separation plane, on a fourth printed-circuit-board layer.

6. The inductive position sensor as claimed in claim 4, wherein the first secondary coil and the second secondary coil are interleaved so that the plane corresponding to the magnetic medium of the first secondary coil coincides with the plane corresponding to the magnetic medium of the second secondary coil.

7. The inductive position sensor as claimed in claim 6, wherein the plane corresponding to the magnetic medium of the first secondary coil and the plane corresponding to the magnetic medium of the second secondary coil coincide with the median plane of the printed circuit board.

8. The inductive position sensor as claimed in claim 1, wherein the at least two secondary windings are placed so that the electromotive forces induced in the turns of one of the at least two secondary windings oppose the electromotive forces induced in the turns of another of the at least two secondary windings.

9. The inductive position sensor as claimed in claim 3, further comprising a second secondary coil comprising a third secondary winding and a fourth secondary winding that are electrically connected at a second transverse separation plane, the first portions of the turns of each of said third secondary winding and fourth secondary winding extending symmetrically on either side of the second transverse separation plane, on a third layer of the printed circuit board.

10. The inductive position sensor as claimed in claim 9, wherein the second secondary coil in addition comprises a fifth secondary winding electrically connected to the fourth secondary winding at a third transverse separation plane, the second portions of the turns of each of said fourth secondary winding and fifth secondary winding extending symmetrically on either side of the third transverse separation plane, on a fourth printed-circuit-board layer.

11. The inductive position sensor as claimed in claim 10, wherein the first secondary coil and the second secondary coil are interleaved so that the plane corresponding to the magnetic medium of the first secondary coil coincides with the plane corresponding to the magnetic medium of the second secondary coil.

12. The inductive position sensor as claimed in claim 11, wherein the plane corresponding to the magnetic medium of the first secondary coil and the plane corresponding to the magnetic medium of the second secondary coil coincide with the median plane of the printed circuit board.

13. The inductive position sensor as claimed in claim 12, wherein the at least two secondary windings are placed so that the electromotive forces induced in the turns of one of the at least two secondary windings oppose the electromotive forces induced in the turns of another of the at least two secondary windings.

14. The inductive position sensor as claimed in claim 5, wherein the first secondary coil and the second secondary coil are interleaved so that the plane corresponding to the magnetic medium of the first secondary coil coincides with the plane corresponding to the magnetic medium of the second secondary coil.

15. The inductive position sensor as claimed in claim 14, wherein the plane corresponding to the magnetic medium of the first secondary coil and the plane corresponding to the magnetic medium of the second secondary coil coincide with the median plane of the printed circuit board.

16. The inductive position sensor as claimed in claim 15, wherein the at least two secondary windings are placed so that the electromotive forces induced in the turns of one of the at least two secondary windings oppose the electromotive forces induced in the turns of another of the at least two secondary windings.

17. The inductive position sensor as claimed in claim 2, wherein the at least two secondary windings are placed so that the electromotive forces induced in the turns of one of the at least two secondary windings oppose the electromotive forces induced in the turns of another of the at least two secondary windings.

18. The inductive position sensor as claimed in claim 3, wherein the at least two secondary windings are placed so that the electromotive forces induced in the turns of one of the at least two secondary windings oppose the electromotive forces induced in the turns of another of the at least two secondary windings.

19. The inductive position sensor as claimed in claim 4, wherein the at least two secondary windings are placed so that the electromotive forces induced in the turns of one of the at least two secondary windings oppose the electromotive forces induced in the turns of another of the at least two secondary windings.

20. The inductive position sensor as claimed in claim 5, wherein the at least two secondary windings are placed so that the electromotive forces induced in the turns of one of the at least two secondary windings oppose the electromotive forces induced in the turns of another of the at least two secondary windings.
